(19) United States
(12) Patent Application Publication
(10) Pub. No.: US 2009/0049033 A1
(43) Pub. Date: Feb. 19, 2009

(54) METHOD OF USER-GENERATED, CONTENT-BASED WEB-DOCUMENT RANKING USING CLIENT-BASED RANKING MODULE AND SYSTEMATIC SCORE CALCULATION

(76) Inventor: Andrei Sedov, Toronto (CA)

Correspondence Address: Andrei Sedov, 215-555 Wilson Heights Blvd., Toronto, ON, M3H 6B5, CA

(21) Appl. No.: 11/840,974

(22) Filed: Aug. 19, 2007

(51) Int. Cl. G06F 17/30

(52) U.S. Cl. 707/5; 707/E17.008

(57) ABSTRACT

Present invention allows a user to rank web-documents that he or she accesses with a web-browser. Ranking of web-documents is facilitated by a client-based ranking module, a software program functionally compatible with a user's web-browser. A user sends voting information together with an identification number unique to each version of the ranking module and the URL of currently active web-document to Modelane ranker system for processing. While voting for the content quality of a web-document, a user is limited to only three options: positive, negative, and zero. Scores for web-documents are calculated in such a way as to give each vote an equal opportunity to affect a score. The method of score calculation is designed to separate the scores for each individual web-document as much as possible. The method allows systematic comparison of web-documents based on popular opinion of their contents and precise ordering of web-documents on a linear scale.

### BACKGROUND OF THE INVENTION

Present invention relates generally to user-generated web-document ranking.

Modern large-scale Internet search engines often use methods of web-document ranking based on mathematical analysis of backward or forward links of a web-document or a combination of those. Others use methods of semantic analysis of content and/or meta-data of web-documents, as known to those skilled in the art. Yet others use data collected from analysis of bookmarks of users to identify most popular web-documents. While methods of content evaluation of web-documents are already popularized like a five-star system of evaluation or a plus/minus system of evaluation, those methods are not generally used to rank web-documents on a linear scale and often do not allow systematic comparison of web-documents by the quality of content. At the same time, those methods of ranking are limited to web-documents provided by a single server and do not allow for a centralized ranking of web-documents provided by multiple servers. All the above-mentioned problems must be solved in order to implement a new web-document ranking method of present invention.

### BRIEF SUMMARY OF THE INVENTION

Present invention makes it easy to compare web-documents systematically with the ranking criterion being the quality of web-documents' content as voted by viewers. Present invention limits voters to only three voting options: positive, zero, and negative. That makes ranking of web-documents a simple process as the ranking is based on the most intuitive and obvious characteristics of content. Present invention gives each individual vote an equal chance to affect the score of a web-document by placing it into a systematic calculation process. Present invention also uses a client-installed voting module that allows ranking of documents provided by any Internet server.

### BRIEF DESCRIPTION OF THE SEVERAL VIEWS OF THE DRAWING

The following drawings are used to illustrate present invention:

FIG. 1 illustrates in a block diagram a network environment in which present invention is implemented;

FIG. 2 illustrates in a block diagram a client system that is a generalization of all computer systems necessary for proper implementation of present invention;

FIG. 3 illustrates a simplified user interface of a web-browser's navigation toolbar;

FIG. 4 illustrates a simplified user interface of the ranking module consistent with present invention;

FIG. 5 illustrates in a flow diagram the architectural operation of a web-browser;

FIG. 6 illustrates in a flow diagram the processes involved in loading of a web-document by a web-browser;

FIG. 7 illustrates in a flow diagram the process by which the ranking module consistent with present invention is used by a user to send voting information, the module's identification number, and the URL of a voted web-document to Modelane ranker server and system through a network consistent with present invention;

FIG. 8 illustrates the processing of the incoming URL, voting, and identification information by Modelane ranker system consistent with present invention;

FIG. 9 illustrates in a flow diagram detailed processing of the voting information by Modelane ranker system and calculation of a score for a voted web-document;

FIG. 10 illustrates in a graph the resulting voting trend of a voted web-document for a potential voting scenario;

FIG. 11 illustrates in a graph the resulting score of a web-document for a potential voting scenario.

### DETAILED DESCRIPTION OF THE INVENTION

Present invention makes use of an innovative feature, a client-installed software ranking module that allows ranking of web-documents provided by any Internet server. Three voting options: positive, negative, and zero allow a voter to choose the best description of the content quality of a web-document without much thinking. The description of the content may not be exact any case as most voters are not trained to distinguish the differences in quality of web-documents systematically. Thus, only general reaction to a web-document's content quality like a “positive” or a “negative” may be valid in the case of ranking of web-documents by users. Similarly, limitation of the voting criterion to only three options makes systematic score calculation for the ranked web-documents a convenient and accurate process.

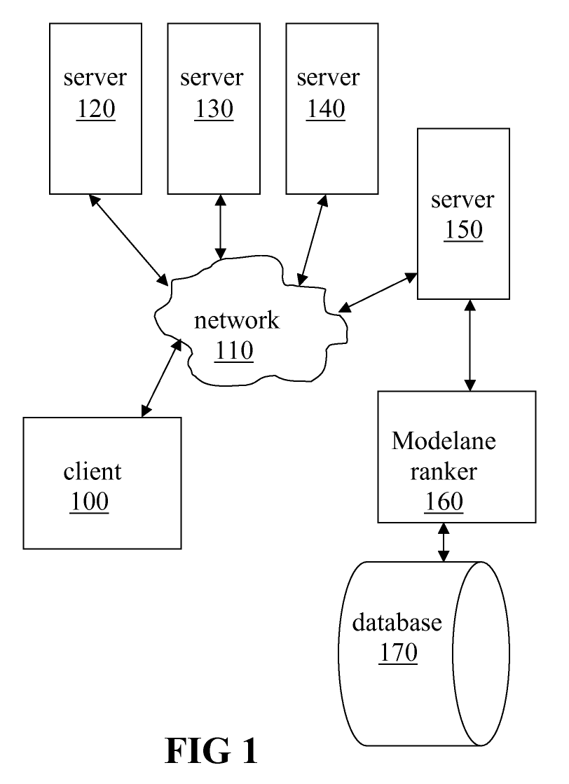

To implement the operations of present invention, a client-server networking model is used. Operations consistent with present invention are performed both on the client side and on the server side of the model. FIG. 1 illustrates a network environment in which the operations of present invention are implemented. According to FIG. 1, the network environment consists of the following components: client system 100, network 110, web-document servers 120, 130, and 140, Modelane server 150, Modelane ranker system 160, and database 170. Client 100 may be a personal computer, a microcomputer, a laptop, or any other device that allows the implementation of operations consistent with present invention. Consistently with present invention, a user of client 100 is able to send information to Modelane ranker 160 via server 150 and network 110 due to client 100's specific hardware and/or software elements. These elements will be discussed below. In addition, client 100 may be used to access information provided by servers 120, 130, 140, and 150. Network 110 may be the Internet, LAN (local area network), a wireless network, or any other kind of network that permits transmission of information between client and server devices. Servers 120, 130, 140, and 150 are similar devices to client 100 except that they have a capacity to provide information stored as web-documents in their memory components to network 110 for access by client 100. Thus, server devices 120, 130, 140, and 150 may be personal computers, microcomputers, laptops, or other kinds of devices that have software and/or hardware elements that allow those servers to connect to network 110 and share information stored in their memory components. For example, server 150 is the server used to provide information processed by Modelane ranker system to network 110 consistently with present invention. Modelane ranker 160 is a hardware/software system that has capabilities analogues to client 100 so that it may receive information from client 100 and also provide information to server 150 for sharing with network 110. Modelane ranker is also a system designed to process information sent by client 100. Consistently with present invention, server devices may perform roles of client devices and client devices may perform roles of server devices on different occasions. As FIG. 1 also shows, database system 170 is also used to store information processed by Modelane ranker 160. Database 170 may be a separate computer device analogues to client 100 but with a massive NVM (non-volatile memory) storage device allowing storage of large quantities of static data. Database 170 may also be an element of Modelane ranker system such as any NVM element with an extended capacity. Servers 120, 130, and 140 are illustrated in FIG. 1 as servers that may provide web-documents to network 110. They also may be connected to other systems and databases that may facilitate their functioning. A web-document, consistently with present invention, may be text, animation, video, or sound file that has a network location name such as URL (universal resource locator).

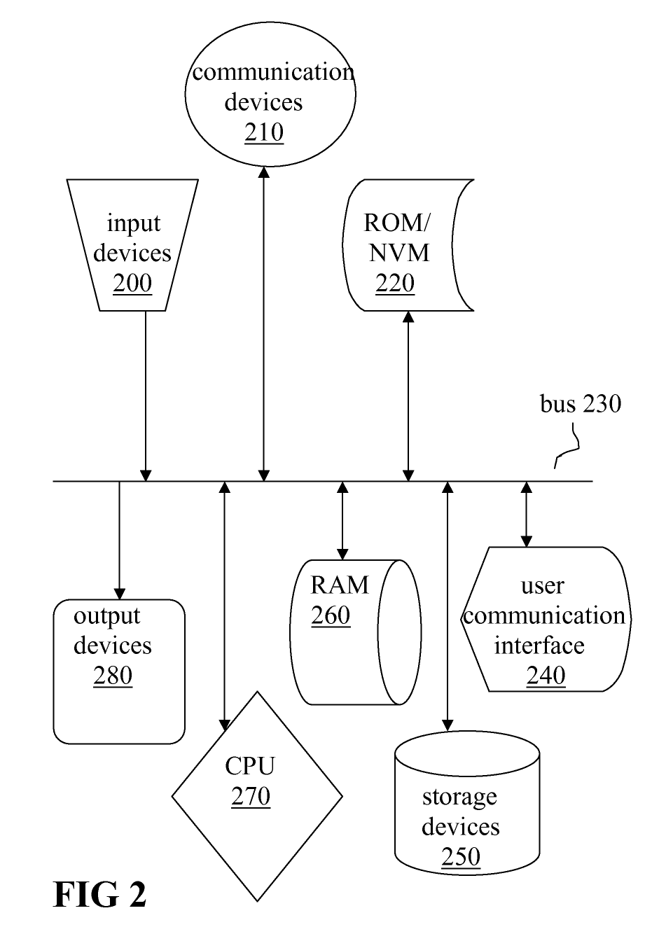

FIG. 2 illustrates the system of client 100. Client 100 system, thus, may consist of input devices 200, communication devices 210, ROM/NVM devices 220, bus 230, user communication interface 240, storage devices 250, RAM 260, CPU 270, and output devices 280. All or most of the listed devices are required to facilitate normal operations of present invention. Input devices 200 may include one or more standard devices like a keyboard or a mouse that allow the input of information into client system 100 for processing by CPU (central processing unit) 270. Communication devices 210 may include one or more standard devices like a modem or a cable plug that allow client 100 system to communicate with other client and server systems. ROM (read-only memory)/NVM devices 220 may include any type of static memory devices that allow storage of static information for processing by CPU 270. An electronic pathway (bus) 230 may be one or more electronic pathways that allow(s) communication between various components of client 100. User communication interface 240 may be any program that allows a user to monitor processes taking place in client system 100 and make necessary changes to those processes. Storage devices 250 may be one or more standard devices that allow data taken from ROM/NVM memory devices 220 to be stored on optical and/or magnetic medium like CD disks. RAM (random access memory) 260 device may be one or more standard dynamic memory devices that allow storage of dynamic memory for processing by CPU 270. CPU 270 may be any electronic microprocessor designed to process information and program tasks stored on any memory device of client 100 and any input into the system of client 100 by any communication or input device. Output devices 280 may be any standard devices like a visual monitor or a speaker that may transform the forms of information stored in the system of client 100 into other forms of information like sound or electron rays for easy comprehension by a user.

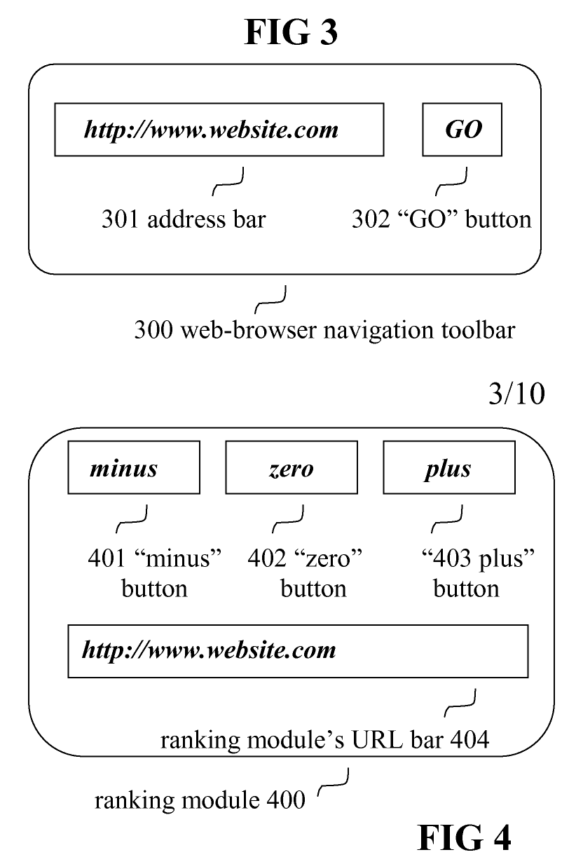

Present invention implies the use of a web-browser or a similar software program designed to allow a user of client 100 to access web-documents provided by servers 120, 130, 140, and 150 to network 110. FIG. 3 illustrates a simplified graphical user interface of a typical web-browser's navigation toolbar 300. Navigation toolbar 300 may include the following components: address bar 301 and “GO” button 302. Navigation toolbar is used for an easy access by a user of a web-document as identified by the web-document's URL. A user may type a URL of a web-document into address bar 301 and press “GO” button 302 to locate and display a web-document. As will be explained below, there is an alternative method of displaying a web-document.

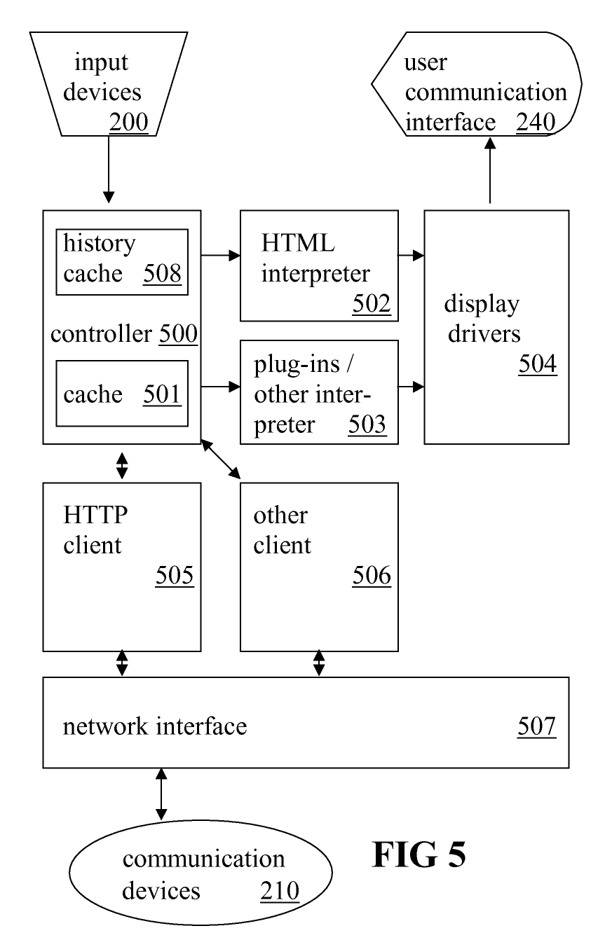

FIG. 5 illustrates a typical system of a web-browser. A web-browser may contain or use the following components: communication devices 210, input devices 200, user communication interface 240, controller 500, cache 501, HTML (HyperText Markup Language) interpreter 502, plug-ins/other interpreter 503, display drivers 504, HTTP (HyperText Transfer Protocol) client 505, other client 506, network interface 507, and history cache 508. When a user types in URL of a web-document into address bar 301 and presses “GO” button 302 using input devices 200, web-browser sends HTTP request to a server via network interface 507 and using communication devices 210. The server that provides the web-document specified by the typed URL sends the web-document to the web-browser via communication devices 210 and network interface 507. Controller 500, the main commander of a web-browser ensures proper coordination of all the components of a web-browser. Thus, controller 500 ensures that the HTTP client 505 sends communication information to a server when a user types in a URL of a web-document. Other internal clients like client 506 is used to communicate with servers using any other additional protocols that may exist. Controller 500 also receives web-documents written in HTML or any other web-programming language. Controller 500 also makes sure that a web-document that contains different forms of information is decoded properly. Thus, an HTML part of a web-document is decoded by HTML interpreter 502 and other parts of a web-document like sound or animation is processed by plug-ins/other interpreter 503. The interpreted web-documents are then organized by display drivers 504 and are finally shown as whole web-documents on user communication interface 240. Certain web-documents that may be marked in a special way are also recorded in cache 501 with all their constituting components for an easy retrieval by controller 500. Web-browsers also typically have a history cache 508 in which the URLs of previously viewed web-documents are recorded for an easy navigation.

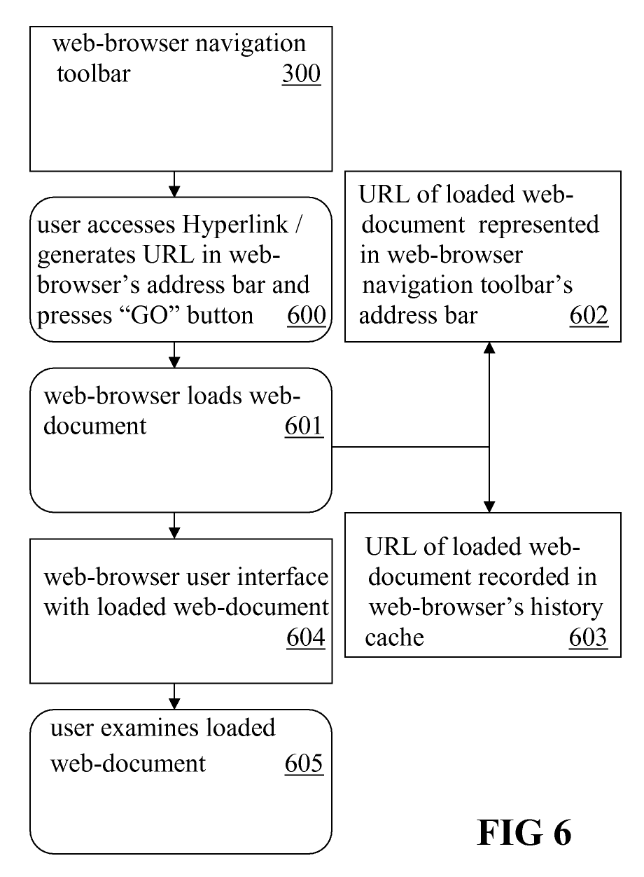

Consistent with present invention, FIG. 6 illustrates the processes involving web-browser's navigation toolbar 300 that occur when a web-document is shown by a web-browser. In stage 600, a user either types a URL of a web-document into web-browser's address bar 301 and presses “GO” button 302 or presses a Hyperlink contained in one of already opened web-documents. In stage 601, a web-browser loads a web-document specified by the URL mentioned in stage 600. In stage 602, URL of the loaded web-document is represented in web-browser toolbar 300's address bar 301. At the same time, in stage 603, the same URL is recorded in web-browser's history cache 508. In stage 604, web-browser shows the web-document specified by the URL mentioned in previous stages of the figure. In stage 605, a user examines the loaded web-document and is ready to rank it using a method described below.

FIG. 4 illustrates the user interface of the ranking module 400 consistent with present invention. The user interface of ranking module consists of the following basic components: “minus” button 401, “zero” button 402, “plus” button 403, and URL bar 404. All three of “minus” button 401, “zero” button 402, and “plus” button 403 are the three options for the ranking criterion consistent with present invention that a user may use to rank a web-document. The labels of the buttons may differ slightly but the basic concepts behind them always stay the same. URL bar 404 is used to represent the URL of currently active web-document that is copied by ranking module 400's program from the web-browser's history cache 508. Consistently with present invention, “currently active web-document” is referring to a web-document that is presently shown in a currently active web-browser window or web-browser's tab as is known to those skilled in the art. A web-document that is “currently active” is also labeled as such in web-browser's history cache 508 that is illustrated in FIG. 5.

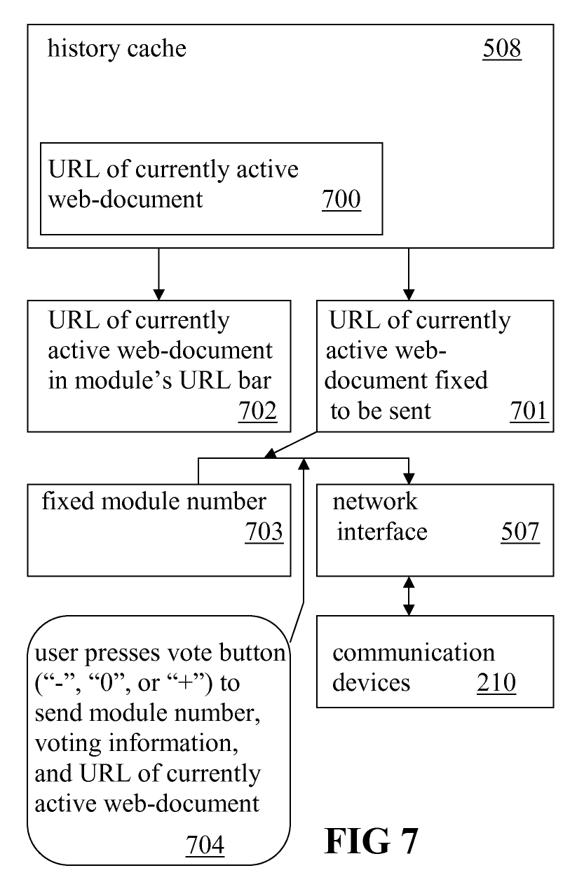

FIG. 7 illustrates the processes involved in client-side ranking of web-documents by a user. First, URL of currently active web-document 700 is copied from web-browser's history cache 508 by one of the ranking module 400's programs. In stage 701, the copied URL 700 is prepared to be sent to Modelane server 150. At the same time, in stage 702, URL 700 is represented in the ranking module 400's URL bar 404. In stage 704, a user presses one of the voting buttons 401, 402, or 403 of the ranking module 400 when he or she is ready to rank a web-document to send a unique identification number 703 of the ranking module 400, the vote, and the fixed URL of currently active web-document 700 to server 150 via network interface 507 and communication devices 210.

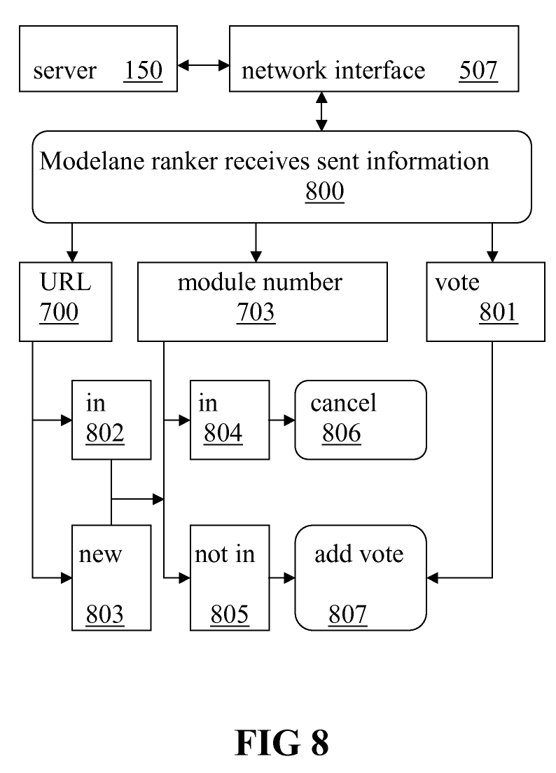

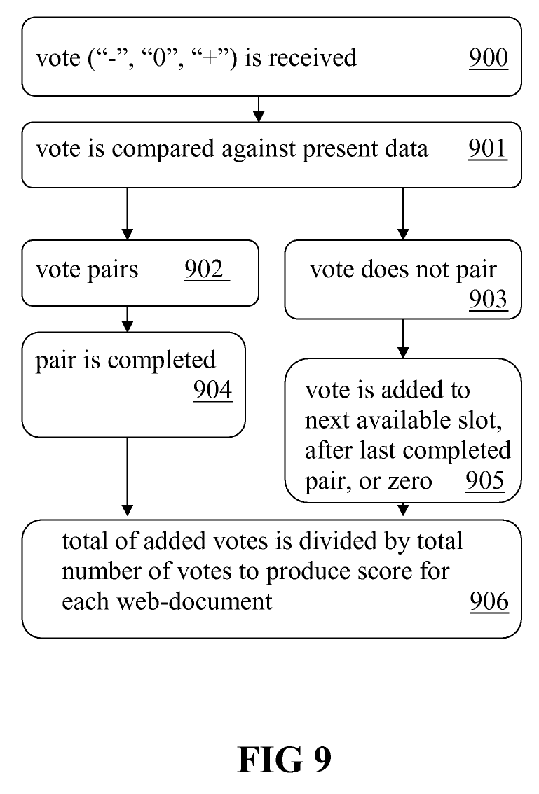

FIG. 8 then illustrates the sever-side processing of the information sent by a user via the ranking module 400. Through server 150 and network interface 507, Modelane ranker 160 receives the sent information in stage 800. The sent information received includes the URL of the voted web-document 700, ranking module 400's unique identification number 703, and a vote 801 that may either be positive, zero, or negative. Modelane ranker 160 then compares the incoming data with database 170 and processes it. There are several possible scenarios that may happen when the received information is processed. Thus, in stage 802, the URL 700 of the voted web-document is already in the database. If it is not in yet, a new record of it is created in stage 803. Then the system checks whether ranking module's identification number 703 is already recorded for that particular URL. In stage 804, identification number 703 is already recorded for that particular URL. That means that the user of that particular ranking module has already voted for that particular web-document. Stage 804 then leads to stage 806 in which any further transactions involving that particular URL and that particular identification number do not happen. On the other hand, in stage 805, identification number 703 is not yet recorded for URL 700 in database 170. That means that no ranking information came yet from that particular ranking module for that particular web-document. Stage 805 proceeds to stage 807 where the vote 801 is added to the database 170 for URL 700 and processed consistently with present invention as illustrated in FIG. 9.

FIG. 9 illustrates the processing of the incoming vote by Modelane ranker 160. Thus, in stage 900, vote 801 is received and it may either be positive, zero, or negative consistently with present invention. In stage 901, the incoming vote is compared against the voting data already recorded for URL 700. Consistently with present invention, ranking system 160 first tries to find pairs in the incoming votes. That is, if one of the votes recorded is minus, then its complementary vote will be plus. The result of pair completion will be zero as “+1” and “−1” mathematically add up to zero. Consistently with present invention, all positive and negative votes are equal to balance each other and each of them has the value of either positive or negative 1. The system 160, thus, tries to complete all the pairs that are still not completed in order to establish a ranking trend for URL 700. The votes are plotted on a two-dimensional space where the two axis are “slots” and “trend #”. With each vote, the next available slot becomes occupied with the incoming vote. At the same time, a trend is produced with each incoming vote. Consistently with present invention, a trend is produced as a result of constant addition of incoming votes to previously recorded votes with the same sign and value (−1, +1, or 0). The result of that addition, the trend of a web-document, is a number (positive or negative) that increases by the value of one with each vote that has the same sign as the trend (negative or positive) or stays the same in the case of zero trend. Each time when a vote comes that is opposite in sign to present trend for a web-document, the trend is broken. Thus, when a vote comes that is opposite in sign to current trend, that vote has to be paired with a vote that is a part of current trend. The trend, then, is decreased in value by exactly one. Consistently with present invention, pairing positive and negative votes occupy very first slots. Pairs always result in a zero and whenever two complementary votes exist in database 170 for URL 700, they must complement to a zero. Because actual zero votes are non-complementary for other zero votes, all zero votes are placed in subsequent slots after the last completed pair to produce a zero trend. All other votes (only positive or only negative) are placed in subsequent slots after the last completed pair or after the last zero vote to produce a positive or negative trend for the web-document. For example, if all subsequent votes following the last zero or the last completed pair are positive, the trend grows by the value of positive one in the positive direction every subsequent slot. On the other hand, if all subsequent votes are negative, the trend grows by the value of negative one in the negative direction every subsequent slot. In FIG. 9, if a vote pairs with another vote in stage 902, the complementary pair is completed in stage 904. On the other hand, if all complementary pairs are already completed and a vote does not form a pair in stage 903, the vote is added to the next available slot in a trend, to the slot after a completed pair, or in a slot after zero trend to produce a trend of a web-document in stage 905. In stage 906, the total of added votes, as represented in the last slot, is divided by the total number of votes to produce a score for a web-document.

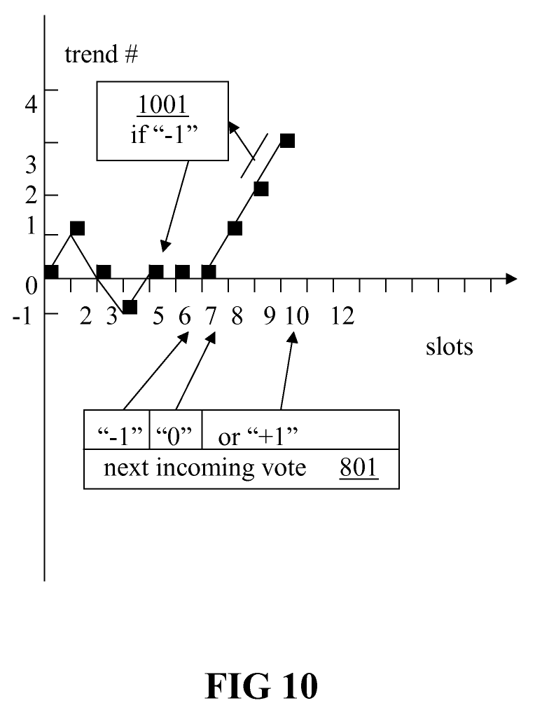

FIG. 10 further illustrates the production of a trend for a web-document. As it was previously described, the votes are plotted on a two-dimensional plotting space where the independent axis is named “slots” and the dependent one is named “trend #”. For a particular web-document, a voting scenario is shown. FIG. 10 illustrates that a total of nine votes were received by the system 160. FIG. 10 shows that two negative, two zero, and five positive votes were received. Thus, two pairs had to be completed that now occupy slots 1/2 and 3/4. The two zero votes follow the last completed pair and they occupy slots 5 and 6. After slot 6, the actual positive trend begins that occupies slots 7, 8, and 9. In slot 9, the final value of the trend is positive three. FIG. 10 also illustrates where the next incoming vote 801 will be placed. Thus, if the vote is “−1”, it will be placed in one of the slots 6 or 5 to form a pair with the “+1” vote that is already located in slot 9. The “+1” vote will be moved to either slot 5 or 6, as illustrated in stage 1001, to complement the incoming negative vote 801. The trend then will be equal only to positive two and will occupy slots 9 and 10. If the incoming vote 801 is “0”, it will be placed in slot 7. In that case, the positive trend will not change its value but simply will move over one slot to occupy slots 8, 9, and 10. If the incoming vote is “+1”, it will simply be placed into the first available slot and its value will be added to current trend. The new trend, thus, will be equal to four and will occupy slots 7, 8, 9, and 10. As FIG. 10 shows, a trend may continue to increase forever, as long as the votes are being added, with possible trend numbers ranging from negative infinity to positive infinity.

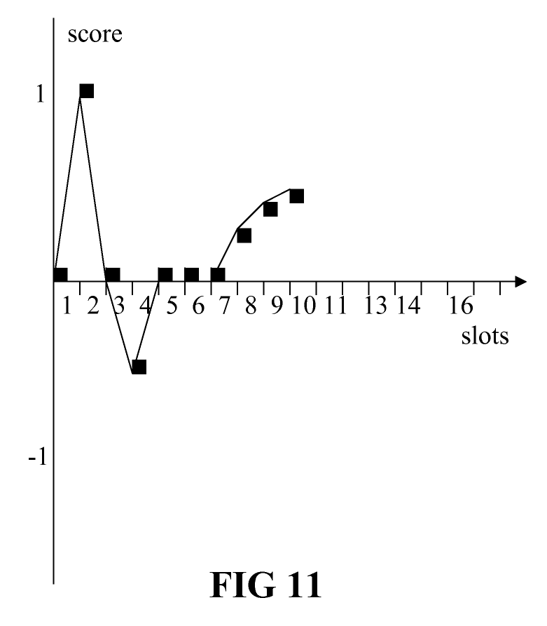

The final score for each slot is calculated by dividing the last trend value by the number of the final occupied slot, the total number of votes received. FIG. 11 illustrates the results of making of a web-document's score based on the trend illustrated in FIG. 10. Since the final trend is positive, the final score is positive too. For each slot of the trend that happens to be the last slot, a score is calculated. Thus, if only one positive vote is received for a web-document, the score will be +1 divided by 1. It is +1. From the last trend value in slot 9 of current voting scenario, it is clear that the score will be +3 divided by 9. It is, thus, +⅓ or 0.333333333 . . . The score of each voted web-document determines its rank in comparison to other voted web-documents. Ranked web-documents may then be arranged by their scores on a linear scale with a range from negative one to positive one.

In conclusion, present invention allows users to vote for a web-document using a client-based ranking module. The ranking module is linked to a user's web-browser in such a way that a web-browser's history cache containing the URLs of current and previously loaded documents is accessible by the ranking module. That linking allows users to send voting information alongside the URL of a voted document to Modelane server for processing. The processing of votes is made simple by limiting the voting options only to three criterion-votes: positive one, zero, and negative one. When a vote is received, the ranking system consistent with present invention organizes the received votes in such a fashion as to make each vote's effect on the overall score of a web-document partially independent of the order in which it's added. The last function is achieved by systematic analysis of each vote in comparison to other votes already received. The ranking and vote organization system described in present text allow precise, systematic comparison of web-documents. To those skilled in the art, it may become clear that the described architecture designed to facilitate present invention may be modified depending on various circumstances. Similarly, future technological developments in the art may allow simplification of the architecture. In no case, however, those modifications will affect the method of ranking and organization of votes described in present text.

The embodiments of the invention in which an exclusive property or privilege is claimed are defined as follows:

1. A. In the Case of a Method—
(1) Ranking of web-documents downloaded with a web-browser by users, the ranking based on web-documents' content quality, with the three ranking criterion-votes allowable being −1, +1, and zero;
(2) Ranking of web-documents specified in claim A(1) by users with a client-based software ranking module, the ranking module having the following capabilities and characteristics:
a unique identification number that is sent to Modelane ranking system of claim A(3) together with other pieces of information;
a user interface with a URL bar in which the URL of currently active web-document is displayed, the term “active” referring to a web-document displayed in either currently opened window or a currently opened tab of a web-browser and labeled in some way as “active” in web-browser's history cache, as known to those skilled in the art;
a function to copy the URL of currently “active” web-document from the history cache of a web-browser and display it in the URL bar of the ranking module mentioned above in this claim;
a user interface with three option buttons for the criterion-votes specified in claim
A(1), each of the buttons initiating sending of information to Modelane ranking system of claim A(3), the three pieces of sent information being the URL of currently active web-document of this claim, unique ranking module's identification number mentioned above in this claim, and one of the three criterion-votes of claim A(1);
a function to organize the three pieces of sent information mentioned above in this claim in an appropriate way so to facilitate their simultaneous sending to Modelane ranking system of claim A(3);
a function to connect to a network, like the Internet, through which sharing of web-documents is possible via any kind of client-side network interface and client communication devices that allow transfer of information through that network interface;
a function to communicate with any software and/or hardware components of a client computer device on which the ranking module is installed in order to implement proper functioning of the method described above in this claim;
(3) Receiving via any functioning network and processing of the information described in claim A(2) by Modelane ranking system that has the following capabilities and characteristics:
a function to receive any information sent by a user with the ranking module of claim A(2) and compare it to previously recorded and processed information sent to Modelane ranking system of this claim with the same method and stored for an easy access by Modelane ranking system of this claim in non-volatile memory device of claim B(5) of computer of claim B(4);
a function to interact with any software and/or hardware systems of claim B(5) of computer of claim B(4) necessary to facilitate proper functioning of Modelane ranking system of this claim;
a function to communicate with and transfer information to any network to which computer of claim B(4) may be connected in order to implement proper functioning of the ranking system of this claim;
a function to process any incoming information sent by a user via the ranking module of claim A(2), the specific processes being: identification of the incoming pieces of information of claim A(2) while separating them, checking whether the URL of a voted web-document of claim A(2) contained in the sent information of claim A(2) is already recorded in non-volatile memory of claim B(5) of computer of claim B(4), checking whether the ranking module's unique identification number of claim A(2) is already recorded in an appropriate directory of non-volatile memory of claim B(5) for the URL of claim A(2), and either adding a criterion-vote of claim A(1) to that directory or not;
a function to make a new directory for the URL of claim A(2) in non-volatile memory of claim B(5) of computer of claim B(4) if a directory for that URL is not already present there;
a function to add claim A(2) ranking module's unique identification number to specific directory for URL of claim A(2) in non-volatile memory of claim B(5) if the identification number is not already recorded in the directory for that particular URL;
a function to add a criterion-vote of claim A(1) to the directory for the URL of claim A(2) in non-volatile memory of claim B(5) if the identification number of the ranking module of claim A(2) is not yet recorded in that directory;
a function to place all the criterion-votes of claim A(1) added to the directory for URL of claim A(2) of non-volatile memory of claim B(5) into a row of slots numbered from 1 to infinity in the order in which the criterion-votes are recorded in non-volatile memory of claim B(5);
a function to check any criterion-votes recorded in the directory for the URL of claim A(2) in non-volatile memory of claim B(5) for any pairing criterion-votes, the term “pairing” referring to a positive-negative criterion-vote pair that complements to a value of zero when the numerical values +1 and −1 of the votes in a pair are added mathematically, in order to make necessary arrangements to the order of slots occupied by the paired and all other criterion-votes;
a function to rearrange the order of criterion-votes in the row of slots of this claim if a positive-negative criterion-vote pair is formed, in which case the two votes forming a pair are moved from their former position in the ordered slots row to the very beginning of the slots row to slots 1 and 2 respectively while advancing all other criterion-votes two slots ahead to occupy the former two slots of the pair and to create continuous and homogeneous lines of criterion-votes with the same sign;
a function to rearrange the order of criterion-votes in the row of slots of this claim if a positive-negative criterion-vote pair is formed, in which case the two votes forming a pair are moved from their former position in the ordered slots row to the two slots located immediately after any slots occupied by previously formed pairs if any previously formed pairs exist while advancing all other criterion-votes two slots ahead to occupy the former two slots of the pair and to create continuous and homogeneous lines of criterion-votes with the same sign;
a function to place any zero criterion-votes of claim A(1) after the slots occupied by any paired votes mentioned above in this claim and before any non-pairing negative or positive criterion-votes arranged in a homogeneous and continuous line mentioned above in this claim;
a function to create a two-dimensional axis plot with the independent axis comprising the slots row numbered from 1 to infinity mentioned above in this claim for the criterion-votes of claim A(1) ever recorded in specific directory for the URL of claim A(2) in non-volatile memory of claim B(5) and the dependent axis, numbered from negative infinity to positive infinity, comprising values of the criterion-votes in the order in which they are recorded or arranged by Modelane ranking system that are added to previously recorded values in a continuously increasing positive or negative step-ladder trend fashion, each value step of the ladder being equal to one and corresponding to each occupied slot;
a function to divide the very last value of a ladder-trend mentioned above in this claim, comprising the final value resulting from the addition of the values of non-pairing criterion-votes and as represented in terms of units of the dependent axis of the two-axis plot mentioned above in this claim, by the positioning number of the very last slot to produce current score value for a voted web-document of claim A(2) represented by the URL of claim A(2) and store that value in non-volatile memory of claim B(5) in specific directory for the URL of claim A(2);
a function to align voted web-documents of claim A(2), the URLs of which are already recorded in non-volatile memory of claim B(5) by their score values in an order from the largest positive value to the largest negative value of their scores, the larges positive score value being positive one and the largest negative score value being negative one.
B. In the Case of an Apparatus —
(4) A computer or microcomputer device required for proper functioning of Modelane ranking system of claim A(3) that allows, at the very minimum, the following operations:
receiving of any information sent by a user via ranking module of claim A(2) through an extraneous network;
processing, in a way specified by an owner/administrator of the system, of any information received by Modelane ranker system of claim A(3);
sharing with an extraneous network some or all of the vote processing information generated as a result of processing of voting information of claim A(2) sent by a user and received by Modelane ranking system of claim A(3) and any other information stored and accessed by Modelane ranking system of claim A(3) as determined by the owner and/or administrator of the system and as required for its proper functioning;
storage of any programs necessary for processing of any information sent by a user via ranking module of claim A(2) to Modelane ranking system of claim A(3) in directories of non-volatile memory device of claim B(5);
access to and interactions with any other devices like another computer or any software system like a database necessary for proper implementation of the method of claims A(1), A(2) and A(3);
(5) A computer or microcomputer device that has, at the very least, components and characteristics listed below in the quantity of at least one of each to facilitate proper functioning of the processes of claim B(4) and Modelane ranking system of claim A(3):
ROM (read only memory) device or other non-volatile memory device that allows storage of large amounts of static information in distinct database directories;
RAM (random access memory) device that allows storage of large amounts of dynamic information;
CPU (central processing unit) or microprocessor that allows execution of any program stored on ROM or other non-volatile memory device mentioned above in this claim, with the use of RAM mentioned above in this claim;
any networking device that allows connection to any network and other microcomputer and computer devices and sharing of any information stored on ROM or other non-volatile memory device mentioned above in this claim;
any software system required for proper interaction of any components mentioned above in this claim and proper functioning of any additional software programs and systems installed to the computer of this claim.
